(19) United States
(12) Patent Application Publication
(10) Pub. No.: US 2004/0005440 A1
(43) Pub. Date: Jan. 8, 2004

(54) Thin-plate-like protective film

(75) Inventors: Kimihiko Sano, Yamanashi-ken (JP); Takio Doi, Osaka (JP); Tadashi Yoshimura, Nagaokakyo-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignees: CASIO MICRONICS CO., LTD., Tokyo (JP); MATSUMOTO CORP., LTD., Osaka (JP)

(21) Appl. No.: 10/609,162

(22) Filed: Jun. 26, 2003

(30) Foreign Application Priority Data
Jul. 5, 2002 (JP) 2002-196770
Feb. 18, 2003 (JP) 2003-039546

(51) Int. Cl. B32B 1/00

(52) U.S. Cl. 428/174

(57) ABSTRACT

Projections are formed on front and back surfaces, respectively, of a thin-plate-like protective film at its widthwise opposite ends. Each of the projections is generally trapezoidal as viewed from an end surface side of the thin-plate-like protective film. Even if the projections are misaligned with respect to the projections when the thin-plate-like protective film is wound around a reel, part of a crown portion of each of the inner projections on an exteriorly located part of the thin-plate-like protective film abuts, via the widthwise opposite ends of base film of the tape-like structure, against part of a crown portion of the corresponding outer projection on an interiorly located part of the thin-plate-like protective film. This hinders the widthwise opposite ends of base film of the tape-like structure from being wavily deformed.

### CROSS-REFERENCE TO RELATED APPLICATIONS

This application is based upon and claims the benefit of priority from the prior Japanese Patent Applications No. 2002-196770, filed Jul. 5, 2002; and No. 2003-039546, filed Feb. 18, 2003, the entire contents of both of which are incorporated herein by reference.

### BACKGROUND OF THE INVENTION

1. Field of the Invention

The present invention relates to a thin-plate-like protective film, and more specifically, to a thin-plate-like protective film used to protect a protected thin-plate-like material structure.

2. Description of the Related Art

For example, with some techniques for packaging a semiconductor chip such as an IC or LSI, a semiconductor chip is mounted on a tape, as in a semiconductor device called a “tape carrier package” (hereinafter referred to as a “TCP”) or a “chip on film” (hereinafter referred to as a “COF”). To manufacture such a semiconductor device, a long tape of tens to hundreds of meters is provided, and various processes, such as an interconnect pattern forming step, a semiconductor chip mounting step, and a resin sealing step are executed on a roll to roll basis.

However, if a protected thin-plate-like material structure such as a tape-like structure is wound directly around a reel, the structure comprising semiconductor chips mounted on interconnect patterns formed on a long tape, then the semiconductor chips and the interconnect patterns are sandwiched between rounds of the tape wound around the reel. Accordingly, the semiconductor chips or the interconnect patterns are often damaged. Thus, for protection, the tape-like structure is superimposed on a thin-plate-like protective film when wound around the reel.

Some conventional thin-plate-like protective films comprise semispherical projections formed, by embossing, at the axial opposite ends of a base film so as to project in alternately different directions at equal pitches in the longitudinal direction of the base film, as described in Jpn. Pat. Appln. KOKOKU No. 8-1916.

However, when this conventional thin-plate-like protective film is wound around the reel, the inner projections on an exteriorly located portion of the thin-plate-like protective film are slightly misaligned with respect to the outer projections on an interiorly located portion of the thin-plate-like protective film, because the exteriorly located portion of the thin-plate-like protective film has a length slightly different from that of the interiorly located portion of the thin-plate-like protective film. When the tape-like structure is sandwiched between these misaligned projections, the widthwise opposite ends of the tape-like structure may be wavily deformed. Such deformations may hinder carriage through sprocket holes formed at the widthwise opposite ends of the tape structure as well as the optical reading of positioning marks formed at the widthwise opposite ends of the tape structure.

This problem is, as described in Jpn. Pat. Appln. KOKOKU No. 8-1916, solved by forming rectangular mounting slots at the widthwise opposite ends of the base film at equal pitches in the longitudinal direction of the base film, injection-molding projections at the respective mounting slots which are each composed of resin, and setting the width of the projection in the longitudinal direction of the base film to be larger than the spacing between the projections in the same direction.

However, the thin-plate-like protective film configured as described above requires the step of injection-molding the projections at the respective mounting slots formed in the base films, the projections being each composed of resin, Consequently, with this film, the number of steps required increases, and in addition to the base film, the resin used to injection-mold the projections is required as a material. This increases costs.

### BRIEF SUMMARY OF THE INVENTION

It is thus an object of the present invention to provide a thin-plate-like protective film that serves to reduce the number of steps required and the amount of material required.

According to a first aspect of the present invention, there is provided a thin-plate-like protective film comprising a thin-plate-like material main body, for example, a base film which protects a protected thin-plate-like material structure, wherein projections are formed in predetermined areas of the thin-plate-like material main body so as to extend from the main body, the projections each having a crown portion substantially parallel with a main surface of the protected thin-plate-like material structure and a side wall portion surrounding the crown portion.

Alternatively, the crown portion may be a plane or may be provided with a plurality of contacts. Furthermore, the side wall portion may be inclined.

On the other hand, a plurality of projections may be provided on the crown portions of which may project in different directions from the main surface of the thin-plate-like material main body. Alternatively, a plurality of projections may be provided which include first projections, projecting from one surface of the thin-plate-like material main body, and second projections projecting from the other surface of thin-plate-like material main body. The first and second projections may be staggered along a direction in which the projections are arranged. Furthermore, the plurality of projections may have an equal width in the direction in which the projections are arranged. Moreover, the plurality of projections may have different widths in the direction in which the projections are arranged. Alternatively, the plurality of projections may be line-symmetrically arranged. Moreover, the plurality of projections may be non-line-symmetrically arranged.

On the other hand, a gap portion may be formed between the plurality of projections. A plurality of gap portions may be formed, some of which have an equal width or different widths.

Further, the projection may be generally trapezoidal as viewed from an end surface side of the thin-plate-like material main body, or U-shaped, as viewed from one surface side of the thin-plate-like material main body, or semicircular, as viewed from one surface side of the thin-plate-like material main body.

The protected thin-plate-like material structure may comprise interconnect patterns so that the predetermined areas of the thin-plate-like material main body are not superimposed on the interconnect pattern. Alternatively, the protected thin-plate-like material structure may comprise interconnect patterns and electronic components such as semiconductor chips so that the predetermined areas of the thin-plate-like material main body are not superimposed on the interconnect patterns or electronic components.

According to the first aspect of the present invention, the projections may be formed, by, for example, embossing, in the predetermined areas of the thin-plate-like material main body so as to extend from the thin-plate-like material main body, the projections each having a crown portion substantially parallel with the main surface of the protected thin-plate-like material structure and the side wall portion around the crown portion. This serves to reduce the number of steps required and the amount of material used. Therefore, cost can be sharply reduced.

Further, in the thin-plate-like protective film according to the first aspect of the present invention, the thin-plate-like material main body may be long enough to protect the protected thin-plate-like material structure, which is also long. Furthermore, the protected thin-plate-like material structure may comprise sprocket holes so that the predetermined areas of the thin-plate-like material main body are in proximity to the sprocket holes. Alternatively, the protected thin-plate-like material may comprise sprocket holes at its widthwise opposite ends, and the predetermined areas of the thin-plate-like material main body may be widthwise opposite ends of the thin-plate-like material main body.

Alternatively, the thin-plate-like material main body may be sheet-like, so as to protect the protected thin-plate-like material structure, which is also sheet-like. Furthermore, the predetermined areas of the thin-plate-like material main body may be two opposite side areas of the thin-plate-like material main body or at least four side areas of the thin-plate-like material main body.

In this thin-plate-like protective film, the whole area other than its crown portions can be separated from the protected thin-plate-like material structure by a predetermined distance. Consequently, even if the protected thin-plate-like material structure is provided with interconnect patterns or semiconductor chips, it is possible to prevent the thin-plate-like protective film from coming into contact with the interconnect patterns or semiconductor chips to damage them.

According to a second aspect of the present invention, there is provided a thin-plate-like protective film comprising a long thin-plate-like material main body which protects a long protected thin-plate-like material structure, wherein conductive layers are provided at least in areas of the thin-plate-like material main body other than at its widthwise opposite ends, for example, on respective surfaces of the thin-plate-like material main body. It is thus possible to make the conductive layers unlikely to rub against other objects. This hinders conductive foreign matter from being generated in the conductive layers.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the embodiments given below, serve to explain the principles of the invention.

FIG. 1 is a plan view showing an example in which a thin-plate-like protective film according to a first embodiment of the present invention is superimposed on a tape-like structure, as viewed from above;

FIG. 2 is a schematic sectional view showing an example of the opposite ends of the tape-like structure, the sectional view being taken along line X-X in FIG. 1;

FIG. 3 is a schematic sectional view showing an example of the opposite ends of the thin-plate-like protective film covering the tape-like structure, the sectional view being taken along line Y-Y in FIG. 1;

FIG. 4 is a fragmentary perspective view showing an example of the thin-plate-like protective film shown in FIG. 1;

FIG. 5A is a side view showing a cut surface obtained when the thin-plate-like protective film shown in FIG. 1 is cut along its width direction, as viewed from the longitudinal direction of a base film;

FIG. 5B is a plan view of the thin-plate-like protective film shown in FIG. 1, as viewed from above;

FIG. 5C is a side view of the thin-plate-like protective film shown in FIG. 1, as viewed from an end of the base film;

FIG. 6 is a schematic sectional view showing another example according the first embodiment of the present invention in which the thin-plate-like protective film covers another tape-like structure;

FIG. 7 is a schematic view showing an example in which the tape-like structure and the thin-plate-like protective film are carried toward a reel according to the first embodiment of the present invention;

FIG. 8 is a fragmentary sectional view showing an example in which the tape-like structure is superimposed on the thin-plate-like protective film when wound around the reel;

FIG. 9 is a side view illustrating an example of misalignment of projections on the thin-plate-like protective film wound around the reel in the case shown in FIG. 8;

FIG. 10 is a side view illustrating another example of misalignment of projections on the thin-plate-like protective film wound around the reel in the case shown in FIG. 8;

FIG. 11 is a plan view showing an example in which the thin-plate-like protective film according to the second embodiment of the present invention is superimposed on three long parallel rows of tape-like structures, as viewed from above;

FIG. 12 is a fragmentary side view showing an example of a thin-plate-like protective film according to a third embodiment of the present invention;

FIG. 13A is a side view showing an example of the relative positional relationship between the projections on the thin-plate-like protective film in FIG. 1;

FIG. 13B is a side view showing another example of the relative positional relationship between the projections on the thin-plate-like protective film in FIG. 1;

FIG. 14 is a side view showing the relative positional relationship between the projections on the thin-plate-like protective film in FIG. 12;

FIG. 15A is a side view showing a cut surface obtained when a thin-plate-like protective film according to a fourth embodiment of the present invention is cut along its width direction, as viewed from the longitudinal direction of a base film;

FIG. 15B is a plan view of the thin-plate-like protective film according to the fourth embodiment of the present invention, as viewed from above;

FIG. 15C is a side view of the thin-plate-like protective film according to the fourth embodiment of the present invention, as viewed from an end of the base film;

FIG. 16A is a side view showing a cut surface obtained when a thin-plate-like protective film according to a fifth embodiment of the present invention is cut along its width direction, as viewed from the longitudinal direction of a base film;

FIG. 16B is a plan view of the thin-plate-like protective film according to the fifth embodiment of the present invention, as viewed from above;

FIG. 16C is a side view of the thin-plate-like protective film according to the fifth embodiment of the present invention, as viewed from an end of the base film;

FIG. 17 is a fragmentary side view showing that the thin-plate-like protective film is superimposed on a tape-like structure when wound around a reel;

FIG. 18 is a plan view showing an example of configuration of a projection on a thin-plate-like protective film according to a sixth embodiment of the present invention;

FIG. 19 is a fragmentary plan view showing an example of configuration of a projection on a thin-plate-like protective film according to a seventh embodiment of the present invention;

FIG. 20A is a side view illustrating the positional relationship between projections arranged at the widthwise opposite ends of a thin-plate-like protective film in a first example according to an eighth embodiment of the present invention;

FIG. 20B is a side view illustrating the positional relationship between projections arranged at the widthwise opposite ends of the thin-plate-like protective film in the first example according to the eighth embodiment of the present invention;

FIG. 21A is a side view illustrating the positional relationship between projections arranged at the widthwise opposite ends of a thin-plate-like protective film in a second example according to the eighth embodiment of the present invention;

FIG. 21B is a side view illustrating the positional relationship between projections arranged at the widthwise opposite ends of the thin-plate-like protective film in the second example according to the eighth embodiment of the present invention;

FIG. 22 is a sectional view illustrating post-baking of a resist film provided on one surface of base film of a tape-like structure according to a ninth embodiment of the present invention;

FIG. 23 is a graph showing a temperature characteristic observed during the post-baking in FIG. 22;

FIG. 24 is a plan view illustrating an example of a tape-like structure shaped like a sheet according to another embodiment of the present embodiment;

FIG. 25 is a plan view illustrating an example of a thin-plate-like protective film shaped like a sheet to protect the tape-like structure shaped like a sheet, shown in FIG. 24;

FIG. 26 is a plan view illustrating another example of a tape-like structure shaped like a sheet; and

FIG. 27 is a plan view illustrating an example of a thin-plate-like protective film shaped like a sheet to protect the tape-like structure shaped like a sheet, shown in FIG. 26.

### DETAILED DESCRIPTION OF THE INVENTION

(First Embodiment)

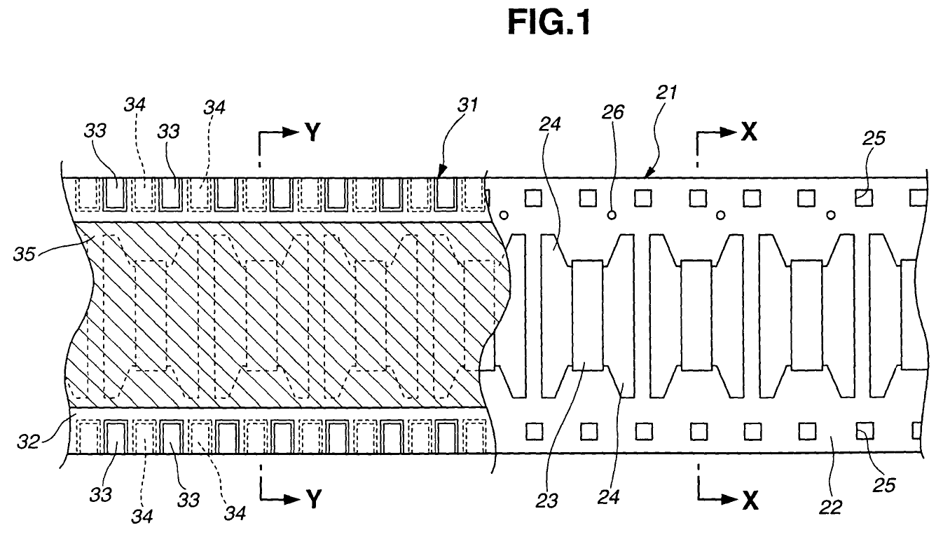

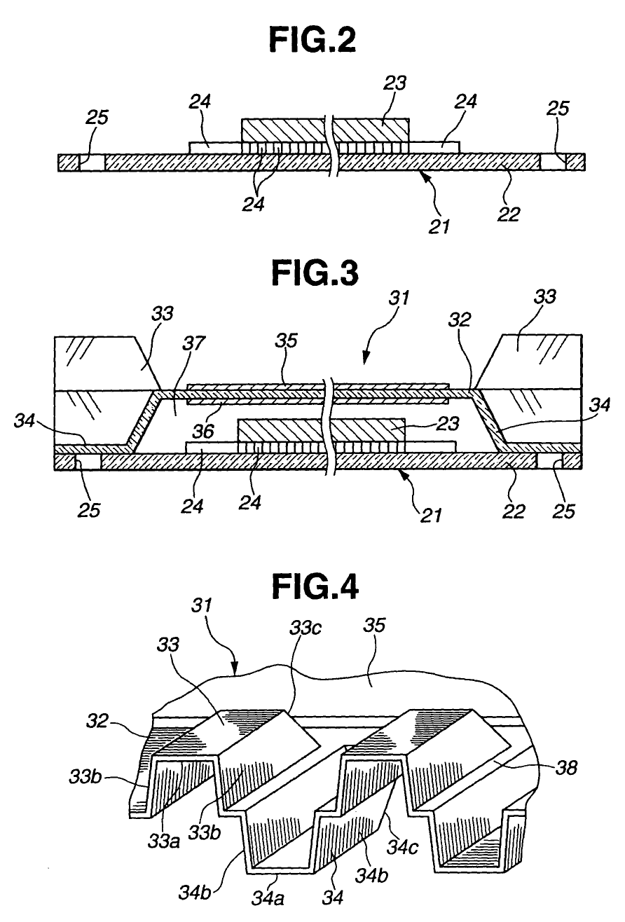

The plan view in FIG. 1 shows an example in which, a thin-plate-like protective film 31 is superimposed on a tape-like structure 21, as viewed from above. The tape-like structure 21 is used as a protected thin-plate-like material structure as a first embodiment of the present invention. The thin-plate-like protective film 31 protects the tape-like structure 21. Further, FIG. 2 is a schematic sectional view showing the opposite ends of the tape-like structure 21, the sectional view taken along line X-X in FIG. 1.

The tape-like structure 21 is a chip on a film composed of a base film 22 that is a long thin-plate-like material main body consisting of polyimide (PI) or polyethylene terephthalate (PET). A plurality of interconnect patterns 24 are provided on at least one of the surfaces of the base film 22. Further, semiconductor chips 23 are each mounted on the corresponding interconnect pattern 24. A plurality of sprocket holes 25 into which respective pin sprockets for carriage are inserted are formed on the widthwise opposite sides of each interconnect pattern 24 at equal pitches in the longitudinal direction of the base film 22. Furthermore, positioning marks 26 are formed, for the respective semiconductor chips 23, on the surface on which the interconnect patterns 24 are provided. The tape-like structure 21 have a width of, for example, 35 or 48 mm.

FIG. 3 is a schematic sectional view showing an example of the opposite ends of a thin-plate-like protective film 31 covering the tape-like structure 21, the sectional view being taken along line Y-Y in FIG. 1.

The thin-plate-like protective film 31 is composed of a base film 32 that is a long thin-plate-like material main body consisting of polyimide (PI), polyethylene terephthalate (PET), polyetherimide (PEI), or the like. Projections 33 and 34 are formed on a front and back surfaces, respectively, of the base film 32 at its widthwise opposite ends by embossing and are alternately arranged at equal pitches in the longitudinal direction of the base film 32. Further, conductive layers 35 and 36 for electrostatic discharge, which consist of a conductive resin containing carbon or a conductive polymer, are provided on the whole surface of the base film 32 other than its widthwise opposite ends, where the projections 33 and 34 are formed. In this case, the single conductive layer 35 and the single conductive layer 36 are provided. However, two conductive layers 35 and two conductive layers 36 may be provided. Alternatively, the conductive layers may be provided so as to cover the entire front and back surfaces, respectively, of the base film 32, including the projections 33 and 34. Alternatively, the conductive layer may be provided on only one surface of the base film 32.

The thin-plate-like protective film 31 can cover and protect the base film 22 because the projections 33 and 34, located at the widthwise opposite ends of the base film 32 and arranged along the longitudinal direction, contact with the base film 22 of the tape-like structure 21. In this case, a space 37 formed between the tape-like structure 21 and the thin-plate-like protective film 31 owing to the height of the projections 33 and 34 is set so that the semiconductor chips 23 and the interconnect patterns 24 do not contact with the thin-plate-like protective film 31.

As shown in FIG. 4, each projection 33 projects upward from a central surface of the base film 32. Each projection 34 projects downward from the central surface of the base film 32. Each of the projections 33 and 34 is generally trapezoidal as viewed from the end surface of the base film 32, and is open on the end surface side of the base film 32. Accordingly, an upper side of each projection 33 or 34 corresponding to the top of trapezoid constitutes a crown portion 33a or 34a, respectively, which is parallel with the base film 32. The crown portions 33a and 34a are set to contact with the base film 22 of the tape-like structure 21. A gap portion 38 is formed between the projections 33 and 34 so as to be flush with the base film 32. Each of the crown portions 33a and 34a has a planar portion contacting with the base film 22 or is set to have a predetermined contact area per unit area.

Description will be given of an example of a method of manufacturing the thin-plate-like protective film 31. First, striped conductive layers 35 and 36 are provided in predetermined areas of the front and back surfaces, respectively, of a base film wide enough to provide a plurality of base films 32. Then, the base film is cut between the conductive layers 35 and 36 to form a plurality of base films 32 each including the conductive layers 35 and 36. Finally, projections 33 and 34 are formed on each base film 32 by embossing.

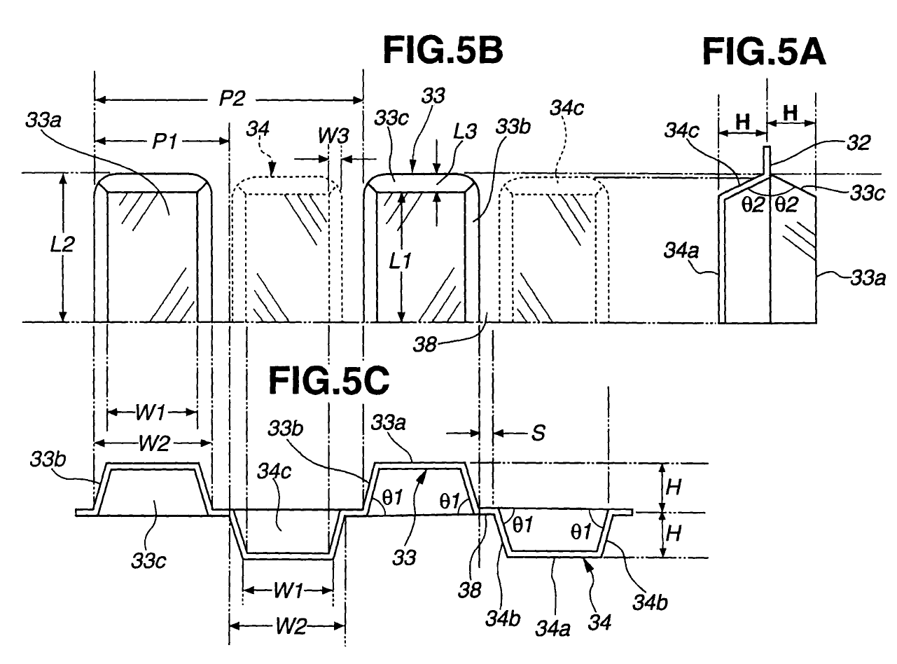

As shown in FIGS. 5A, 5B, and 5C, the projections 33 and 34 are each shaped like a trapezoid in which the crown portion 33a or 34a constitutes an upper bottom and in which the base film 32, which is longer than the upper bottom, constitutes a lower bottom. In the projections 33 and 34, the width W1 of their crown portions 33a and 34a, each of which corresponds to the upper bottom, is desirably set to be smaller than a width W2 corresponding to the lower bottom in order to allow an embossing mold to be easily released. That is, side wall portions 33b and 34b of the projections 33 and 34, which correspond to the inclined sides of the trapezoid, are desirably inclined at an angle of less than 90° to the base film 32. In FIGS. 5A, 5B, and 5C, the conductive layers 35 and 36 and the end side projections 33 and 34 are omitted.

On the other hand, to increase the area of each crown portion 33a or 34a which contacts with the base film 22 of the tape-like structure 21, the ratio of the width W1 of the crown portion 33a or 34a to the width W2 is desirably large. Further, it is desirable to minimize the ratio of the spacing S between the adjacent projections 33 and 34 to the interval P1 of each projection 33 or 34 and the interval P2 between the two projections 33 and 33 (=the interval between the two projections 34 and 34).

Thus, the side wall portions 33b and 34b of the projections 33 and 34, which correspond to the inclined sides of the trapezoid, are inclined at an angle θ1 to the base film 32. Preferably, 45°≦θ1≦88°, more preferably, 83°≦θ1≦88°.

In this case, as shown in FIG. 1, the base film 32 of the thin-plate-like protective film 31 has substantially the same width as that of the tape-like structure 21 to be protected. Further, at the widthwise opposite ends of the base film 32 of the thin-plate-like protective film 31, the same projections 33 are arranged opposite each other, and the same projections 34 are arranged opposite each other. That is, the projections 33 and 34 are linearly symmetrically arranged.

Side wall portions 33c and 34c of the projections 33 and 34, which are opposite the open sides, are inclined at an angle θ2. If the length L1 of each crown portion 33a or 34a is as large as the width L1, a sufficient contact area can be maintained between the crown portion 33a or 34a and the tape-like structure 21. The tape-like structure 21 is formed with sprocket holes 25. Thus, the thin-plate-like protective film 31, which has substantially the same dimensions as those of the tape-like structure 21, has a relatively large space in its width direction. Consequently, the side wall portions 33c and 34c can be formed to be large enough to allow the embossing mold to be easily released. That is, the angle θ2 can be set to be smaller than the angle θ1. Preferably, 30°≦θ2≦75°.

The spacing between the projection 33 or 34 and the conductive layers 35 and 36 has an appropriate length in consideration of misalignment that may occur when the conductive layers 35 and 36 are applied and formed. However, it is preferably minimized because a sufficient electrostatic discharge effect is expected when the conductive layers 35 and 36 are extended so as to sufficiently cover the opposite semiconductor chips 23 and interconnect patterns 24. The height H of each projection 33 or 34 and the size of each crown portion 33a or 34a are properly set.

As shown in FIG. 3, when the thin-plate-like protective film 31 must protect not only those areas of the base film 22 which surround the sprocket holes 25 and positioning marks 26 but also the semiconductor chips 23 and interconnect patterns 24, the height H of each projection 33 or 34 must be sufficient to prevent the semiconductor chips 23 and the interconnect patterns 24 from contacting with the thin-plate-like protective film 31 when the tape-like structure 21 protected by the thin-plate-like protective film 31 is housed in a reel.

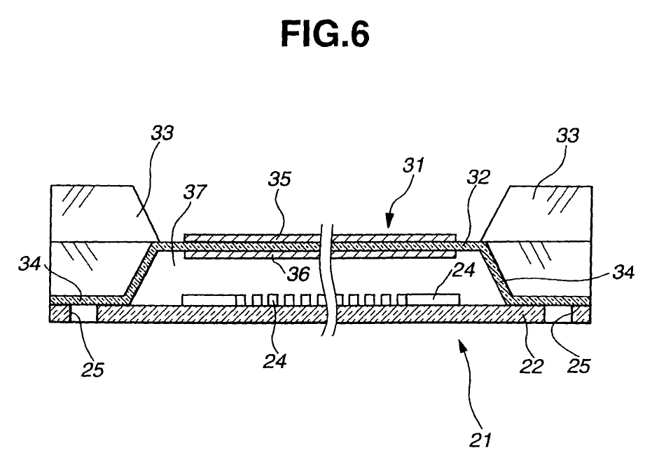

Further, as shown in FIG. 6, provided that the tape-like structure 21 is not formed with any semiconductor chips 23, the height H of each projection 33 or 34 has only to be sufficient to prevent at least the interconnect patterns 24 from contacting with the thin-plate-like protective film 31 when the tape-like structure 21 protected by the thin-plate-like protective film 31 is housed in the reel.

The base film 32 has a thickness of, for example, about 25 to 480 μm, preferably about 125 to 250 μm. Each of the conductive layers 35 and 36 has a thickness of, for example, about 2 μm. If the tape-like structure 21 is 35 mm in width, the conductors 35 and 36 are set to be about 23 mm in width, and the projections 33 and 34 are set to have a length L2 of about 4.5 mm. If the tape-like structure 21 is 48 mm in width, the conductors 35 and 36 are set to be about 36 mm in width, and the projections 33 and 34 are set to have a length L2 of about 4.5 mm. The projections 33 and 34 are set to have a width W1 of about 3.98 mm, a width W2 of about 4.3 mm, a width W3 of about 0.16 mm, and a height H of about 1.8 mm. The projections 33 and 34 are set to have a pitch P1 of about 5.0 mm and a pitch P2 of about 10 mm. The width S of the gap portion 38 is set to be about 0.7 mm.

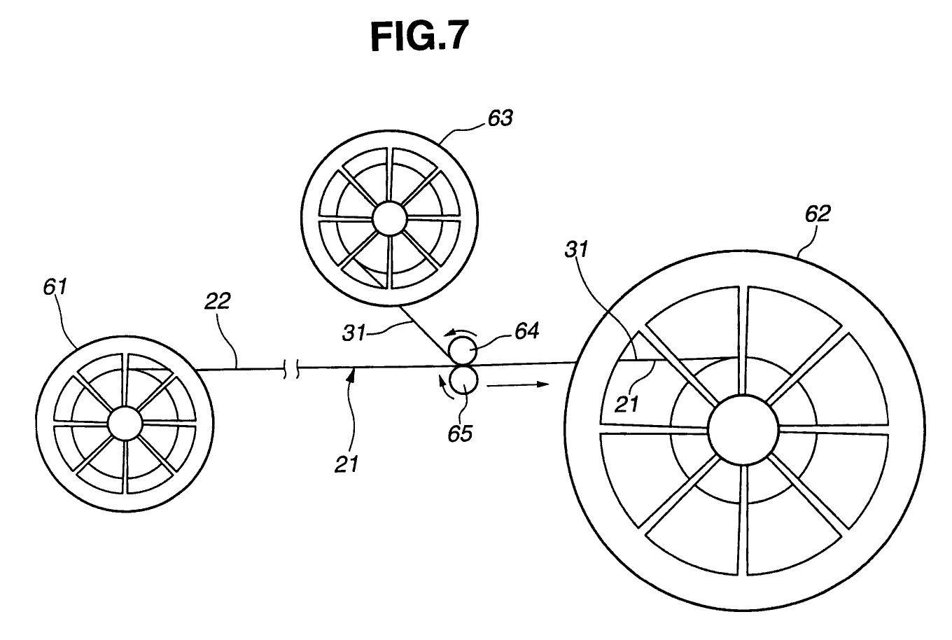

As shown in FIG. 7, the base film 22 carried from a reel 61 undergoes formation of the interconnect patterns 24 and other steps, and is finally formed into the tape-like structure 21, which is then carried toward a reel 62. During the carriage, the completed tape-like structure 21 is pressed by rollers 64 and 65 against the thin-plate-like protective film 31 housed in the reel 63 and the tape-like structure 21 housed in the reel 61 respectively so that one surface of the tape-like structure 21 is covered with the thin-plate-like protective film 31. The thin-plate-like protective film 31 from the rollers 64 and 65 is assembled on the tape-like structure 21 as shown in FIG. 3. The thin-plate-like protective film 31 is then housed in a reel 62 in the assembled condition. When the thin-plate-like protective film is wound around the reel 62, at least one of the conductive layers 35 and 36 of the thin-plate-like protective film 31 contacts with a conductive shaft of the reel 62. This shaft is grounded. Thus, static electricity remaining on the tape-like structure 21 during the carriage is discharged to the shaft of the reel 62 via the thin-plate-like protective film 31.

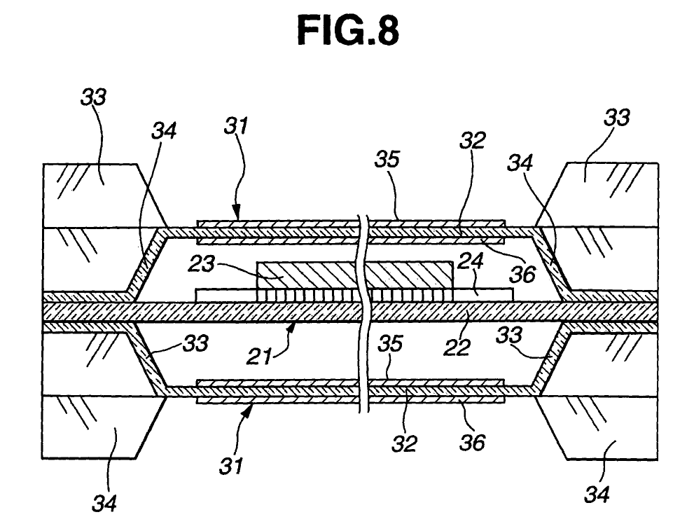

As shown in FIG. 8, if the tape-like structure 21 is superimposed on the thin-plate-like protective film 31 when wound around the reel 62, the outside (the upper side of FIG. 8) of a predetermined portion of the tape-like structure 21 is contacted with the projections 34 on the inside (the lower side of FIG. 8) of that part of the thin-plate-like protective film 31 which is assembled on this portion of the tape-like structure 21. Further, the inside (the lower side of FIG. 8) of this portion of the tape-like structure 21 is contacted with the projections 33 on the outside of that part of the thin-plate-like protective film 31 which is assembled on the next interior portion of the tape-like structure 21. In this manner, the projections 33 and 34 sandwich the widthwise opposite ends of the base film 22 of corresponding portion of the tape-like structure 21 between themselves.

Accordingly, the thin-plate-like protective film 31 firmly supports the base film 22 on a plane in the vertical direction. Consequently, the base film 22 is hindered from sliding in its width direction or longitudinal direction relative to the thin-plate-like protective film 31. Further, the thin-plate-like protective films 31 are unlikely to slide in their width direction or longitudinal direction relative to each other. Thus, the semiconductor chips 23, the interconnect patterns 24, or others do not contact with the thin-plate-like protective film 31 or the reel, thus preventing damage.

Even with the thin-plate-like protective films 31 according to this embodiment, when it is wound around the reel 62, an exteriorly located portion of the thin-plate-like protective film 31 has a length slightly different from that of an interiorly located portion of the thin-plate-like protective film 31. Thus, the inner projections on an exteriorly located portion of the thin-plate-like protective film 31 may be slightly misaligned with respect to the outer projections on an interiorly located portion of the thin-plate-like protective film 31 in the longitudinal direction of the thin-plate-like protective film 31.

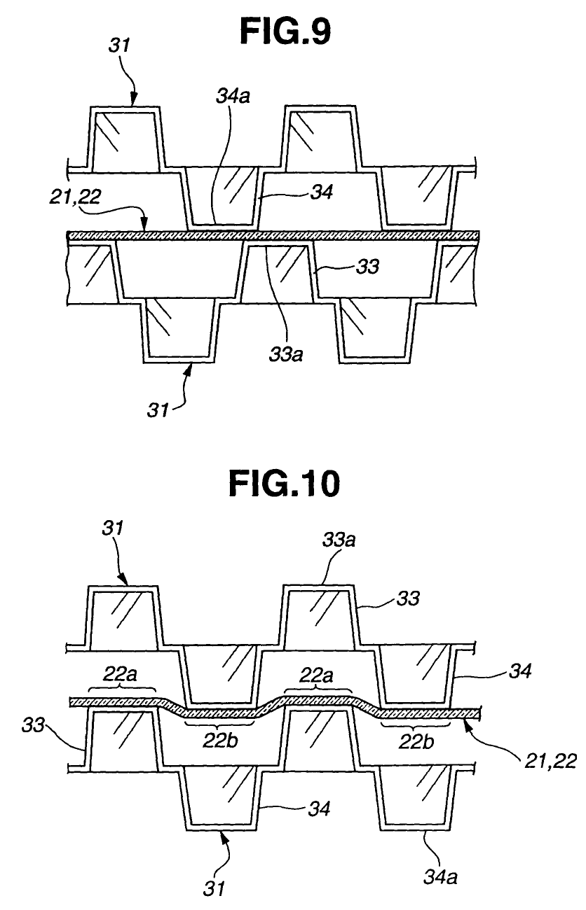

In this case, as shown, for example, in FIG. 9, part of the crown portion 34a of each inner projection 34 on any exteriorly located portion of the thin-plate-like protective film is contacted with part of the crown portion 33a of the corresponding outer projection 33 on the corresponding interiorly located portion of the thin-plate-like protective film via the widthwise opposite ends of base film 22 of the tape-like structure 21. This perfectly prevents the inner projections 34 on the exteriorly located portion of the thin-plate-like protective film 31 from cutting into the corresponding outer projections 33 on the interiorly located portion of the thin-plate-like protective film 31.

In this regard, even if the projections 33 and 34 on the exteriorly located portion of the thin-plate-like protective film 31 are perfectly aligned with the corresponding projections 33 and 34 on the interiorly located portion of the thin-plate-like protective film 31 as shown in, for example, FIG. 10, the former projections do not markedly force themselves into the latter projections.

Since the exteriorly located portion of the thin-plate-like protective film 31 has a length slightly different from that of interiorly located portion of the thin-plate-like protective film 31, the projection 34 may not face an abutting position 22a at which the base film 22 abuts against the crown portion 33a of the projection 33 as shown FIG. 10. However, immediately outside the abutting position 22a, an abutment position 22b is arranged at which the base film 22 abuts against the crown portion 34a of the projection 34. Similarly, the projection 33 may not face the abutting position 22b. However, the abutment position 22a is arranged immediately outside the abutting position 22b.

Specifically, the abutting position 22a has a large supporting area because it is a surface in contact with the base film 22 rather than being in point contact with the film 22. Thus, even though the projection 33 does not face the crown portion 34a of the projection 34 via the base film 22, the abutting position 22b, which similarly has a large supporting area, supports the base film 22 at both outer sides of the abutting position 22a from the vertically opposite direction. Likewise, the abutting position 22b has a large supporting area because it is in surface contact with the base film 22 rather than being in point contact with the film 22. Thus, even though the projection 34 does not face the crown portion 33a of the projection 33 via the base film 22, the abutting position 22a, which similarly has a large supporting area, supports the base film 22 at both outer sides of the abutting position 22b from the vertically opposite direction.

In this manner, the tape-like structure 21 is supported in a well-balanced manner by the crown portions 33a and 34a of the projections 33 and 34, which abut alternately against the abutting positions 22a and 22b, respectively, the abutting positions 22a and 22b both having a large supporting area. This prevents loads from concentrating locally on the base film 22. Thus, the base film 22 is not wavily deformed as in the prior art. Therefore, the semiconductor chips 23 or the interconnect patterns 24 are not crushed by the thin-plate-like protective film 31.

Further, the thin-plate-like protective film 31 does not markedly force itself into the tape-like structure 21. This prevents an exteriorly located portion of the thin-plate-like protective film 31 from being misaligned with respect to a corresponding interiorly located portion of the thin-plate-like protective film 31 in their width direction and in a direction in which they are separated from each other. Thus, the thin-plate-like protective film 31 and the tape-like structure 21 can be appropriately wound around the reel 62 from innermost round to outermost round. With a conventional thin-plate-like protective film with semispherical projections, when it is wound around the reel, the misalignment of the projections may occur not only in its longitudinal direction but also in its width direction. In this case, the widthwise opposite ends of the tape-like structure may not only be deformed wavily but an exteriorly located portion of the thin-plate-like protective film may be misaligned with respect to a corresponding interiorly located portion of the thin-plate-like protective film in their width direction and in a direction in which they are separated from each other.

As described above, the thin-plate-like protective film 31 of this embodiment serves to hinder wavy deformation at the widthwise opposite ends of the base film 22 of the tape-like structure 21, on which the sprocket holes 25 and the positioning marks 26 are arranged. As a result, it is possible to avoid the hindrance of carriage through the sprocket holes 25, formed at the widthwise opposite ends of the base film 22 and of the optical reading of the positioning marks formed at the widthwise opposite ends of the tape structure. Further, the thin-plate-like protective film 31 can be correctly wound around the reel 63 together with the tape-like structure 21 without being misaligned in its width direction. This hinders the widthwise opposite ends of the base film 32 from rubbing against the inner surfaces of both flanges of the reel 62. This in turn hinders the generation of dust attributed to the rubbing.

Further, the conductive layers 35 and 36 are provided over the whole front and back surfaces, respectively, of the base film 32 of the thin-plate-like protective film 31 other than its widthwise opposite ends, where the projections 33 and 34 are formed. Thus, if the thin-plate-like protective film 31 comes into contact with the inner surface of the flange, the conductive layers 35 and 36 will not rub against the widthwise opposite ends of base film 22 of the tape-like structure 21 or the inner surface of flange of the reel 62. This hinders conductive foreign matter from being generated in the conductive layers 35 and 36. As a result, it is possible to prevent the short circuiting of the tape-like structure 21 attributed to such conductive foreign matter.

(Second Embodiment)

In the first embodiment, description has been given of the thin-plate-like protective film 31 conforming to the single long row of tape-like structure 21. However, the thin-plate-like protective film of the present invention is not limited to this configuration.

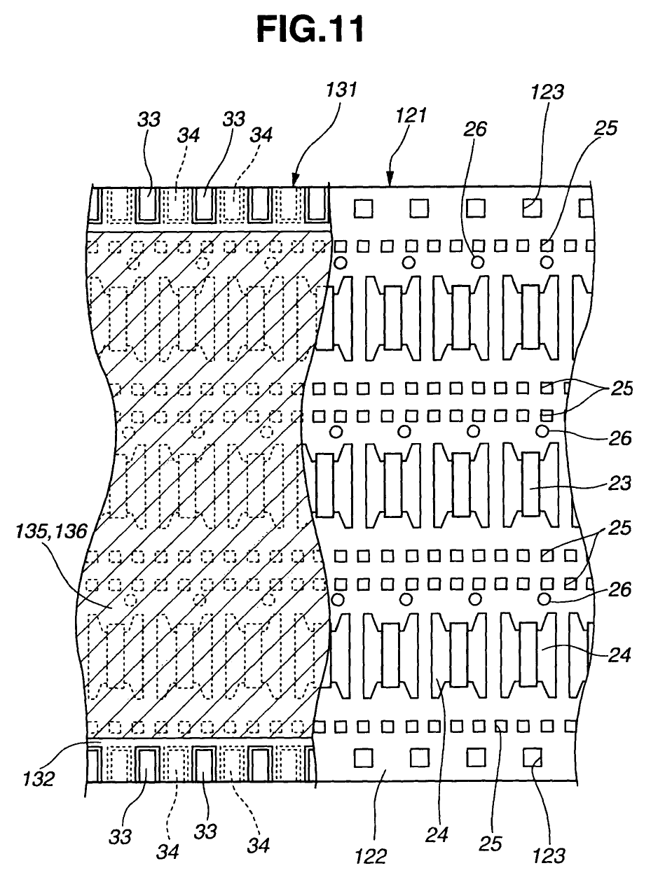

For example, as shown in a second embodiment in FIG. 11, a thin-plate-like protective film 131 may be provided which conforms to three long parallel rows of tape-like structures 121. The tape-like structures 121 have substantially the same material and functions as those of the tape-like structure 21 except that a base film 122 is composed of three rows of base films 33 and that a plurality of sprocket holes for carriage 123 formed at the widthwise opposite ends of the base film 122 and along the longitudinal direction of the base film 122.

The thin-plate-like protective film 131 comprises a base film 132 having material and functions similar to those of the base film 32. A plurality of projections 33 and 34 are provided along the longitudinal direction of the base film 132. Conductive layers 135 and 136 similar to the conductive layers 35 and 36 are provided on the front and back surfaces, respectively, of base film 132 of the thin-plate-like protective film 131 in areas corresponding to the semiconductor chips 23 and interconnect patterns 24 on the tape-like structure 121.

If the base film 122 of the tape-like structure 121 is 158 mm in width, the thin-plate-like protective film 131 is desirably set to have a width of 158 to 162 mm, i.e. a slightly larger width than the tape-like structure 121. Further, in this case, the thickness of base film 132 of the thin-plate-like protective film 131 is set to be larger than that of one row of base film 32, i.e. it is set at about 250 μm when the thickness of one row of base film 32 is about 188 μm. The thickness and width of each conductive layer 135 or 136 are about 2 μm and about 150 mm, respectively. Now, description will be given with reference to FIG. 5. The projections 33 and 34 have a length L2 of about 5.7 mm, a width W1 of about 3.98 mm, a width W2 of about 4.3 mm, a width W3 of about 0.16 mm, and a height H of about 1.8 mm. The pitches P1 and P2 of the projections 33 and 34 are set at about 5.0 mm and 10.0 mm, respectively. The width S of the gap portion is set at about 0.7 mm.

The projections 33 and 34 are provided only at the widthwise opposite ends of the base film 132. However, they may be provided in the vicinity of the sprocket holes in each row on the base film 132 and along the longitudinal direction of the base film 132 unless they contact with the semiconductor chips 23 or the interconnect patterns 24.

(Third Embodiment)

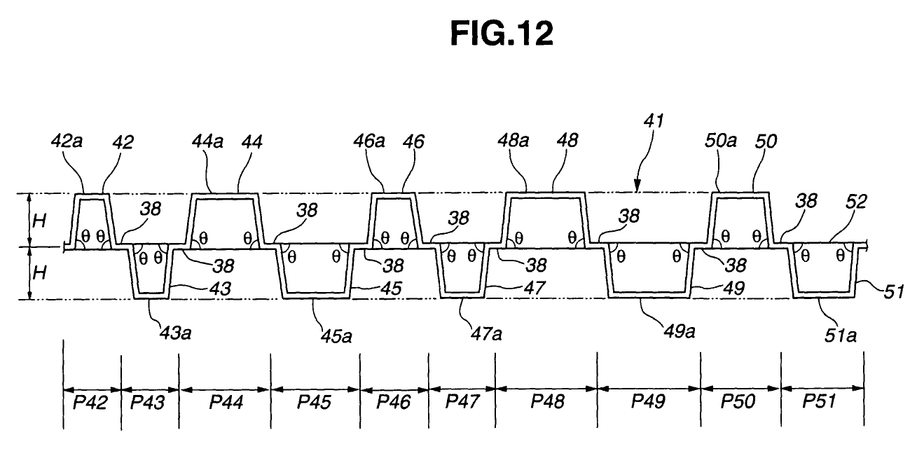

In the first and second embodiments, the projections 33 and 34 on the thin-plate-like protective film 31 have the same shape and pitch as viewed from the end surface of the base film 32, as shown in, for example, FIGS. 1 and 4. However, the thin-plate-like protective film of the present invention is not limited to this configuration. For example, as shown in FIG. 12, projections 42 to 51 have the same height but the shapes of the projections 42 to 51 and the widths of the crown portions 42a to 51a as viewed from the end surface of the thin-plate-like protective film 41 may be at least partly different from one another.

The thin-plate-like protective film 41 is designed so that units are repeatedly consecutively arranged in the longitudinal direction, each unit being composed of a first projection 42 on one surface, a first projection 43 on the other surface, a second projection 44 on one surface, a second projection 45 on the other surface, a third projection 46 on one surface, a third projection 47 on the other surface, a fourth projection 48 on one surface, a fourth projection 49 on the other surface, a fifth projection 50 on one surface, and a fifth projection 51 on the other surface, as shown from left to right in FIG. 12. In this case, the gap portion is formed between every adjacent two of the projections 42 to 51.

Each of the projections 42 and 43 is generally trapezoidal as viewed from the end surface side, with each of the angles on the lower bottom of the trapezoid set at θ. Further, every adjacent two of the projections 42 to 51 project from the base film surface in alternately opposite directions. Furthermore, all projections have the height H, and the surface of each crown portion is set to be parallel with the surface of the base film 22, i.e. to be parallel with the surface of the base film 52. In FIG. 12, the illustration of the conductive layers 35 and 36 is omitted.

In this case, when, for example, one unit of the thin-plate-like protective film 41, shown in FIG. 12, has a length of 50 mm, distances P42 to P51, i.e. the distance between the centers of the gap portions 38 at the respective sides of the corresponding projection, are set at 3 mm, 3 mm, 6 mm, 6 mm, 4 mm, 4 mm, 7 mm, 7 mm, 5 mm, and 5 mm, respectively. The size of each gap portion 38 is set at 0.7 mm. Further, the widths of the crown portions 42a to 51a are set at 2.08 mm, 2.08 mm, 5.08 mm, 5.08 mm, 3.08 mm, 3.08 mm, 6.08 mm, 6.08 mm, 4.08 mm, and 4.08 mm, respectively.

With the structure shown in FIG. 1, loads are most uniformly imposed on the tape-like structure 21 when the projections 33 and 34 on the thin-plate-like protective film 31 wound around the reel 62 have their crown portions 33a and 34a lie opposite each other so as to be perfectly superimposed on each other via the tape-like structure 21 as shown in FIG. 8. Thus, the distortion of the tape-like structure 21 can be minimized. However, if the crown portions 33a and 34a are totally misaligned with respect to each other, the tape-like structure 21 is likely to be slightly distorted.

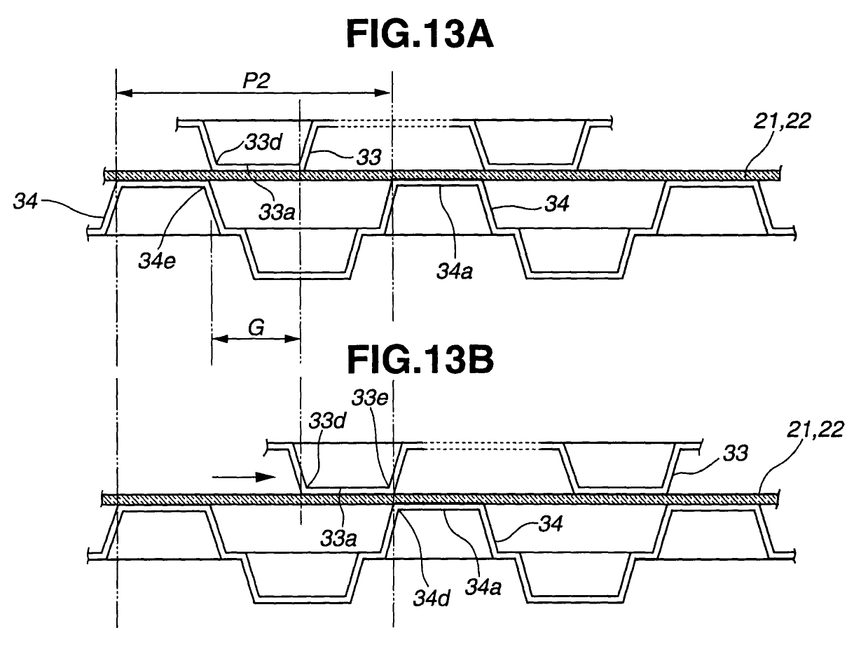

In this regard, as shown in FIGS. 13A and 13B, the position of one crown corner 33d of the outer projection 33 relative to the corresponding inner projection 34 is limited within the interval P2. Then, the crown portion 33a of the outer projection 33 is totally misaligned with respect to the crown portion 34a of the corresponding projection 34 only within the distance G between the position of crown corner 33d of the projection 33 observed when the crown corner 33d is not superimposed on one crown corner portion 34e of the projection 34 and the position of crown corner 33d of the projection 33 observed when the other crown corner 33e of the projection 33 is not superimposed on the other crown corner 34d of the projection 34.

However, the intervals P1 and P2 of the projections 33 and 34 are always uniform in the longitudinal direction of the thin-plate-like protective film 31. Accordingly, if a total misalignment between the crown portion 33a of any outer projection 33 and the crown portion 34a of the corresponding projection 34 is caused by a gap caused by a variation in a diameter of the thin-plate-like protective film 31 wound around the reel, then the misalignment propagates continuously in the longitudinal direction of the thin-plate-like protective film 31.

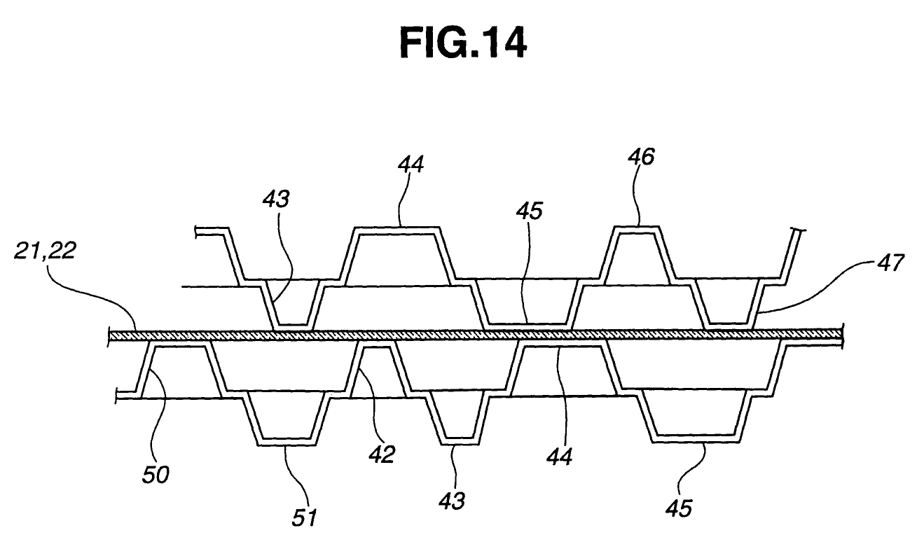

In the third embodiment shown in FIG. 12, some of the projections have different intervals. Accordingly, even if the projection 43 on any outer portion of the thin-plate-like protective film 41 lies opposite the projection 51 on the corresponding inner portion of the thin-plate-like protective film 41 via the base film 22 of the tape-like structure 21 so that the outer projection 43 is not contacted with any other projections via the base film 22 as shown in, for example, FIG. 14, the projection 45 on the outer portion of the thin-plate-like protective film 41 contacts with the projection 44 on the inner portion of the thin-plate-like protective film 41 via the base film 22 of the tape-like structure.

In this manner, when at least some of the projections have different intervals Pi and P2 or at least some of the crown portions of the projections have different widths, certain projections can be placed opposite each other and in surface contact with each other so as to avoid loosening the base film 22. This prevents the consecutive longitudinal arrangement of areas in which the base film 22 cannot be simultaneously supported from both sides. Thus, the base film 22 is more unlikely to be deformed. In FIG. 14, the illustration of the conductive layers 35 and 36 and semiconductor chips 23 or interconnect patterns 24 is omitted.

In this case, it is more preferable to arrange, before and after a pair of projections of the same length such as the pair of third projections 46 and 47 having the intervals P46 and P47, pairs of projections (second projections 44 and 45 and fourth projections 48 and 49) having intervals P44, P45 and P48, P49 relatively significantly different from the intervals P46 and 47 than to arrange, before and after the above pair, pairs of projections (first projections 42 and 43 and fifth projections 50 and 51) having intervals not significantly different from the intervals P46 and 47.

In the third embodiment, the adjacent projections of each pair, i.e. the pair of projections 42 and 43, the pair of projections 44 and 45, the pair of projections 46 and 47, the pair of projections 48 and 49, or the pair of projections 50 and 51, are set to have equal intervals and equal crown portion width. However, the projections of each pair need not necessarily be adjacent to each other as long as the crown portions of these projections have an equal height and have their surfaces set to be parallel with the surface of the base film 52. Further, these projections need not necessarily form a pair or the number of pairs need not necessarily be five.

A tape carrier package on which no semiconductor chips 23 are mounted as shown in FIG. 6 is also applicable to the third embodiment. The thin-plate-like protective film may be superimposed on this tape carrier package.

(Fourth Embodiment)

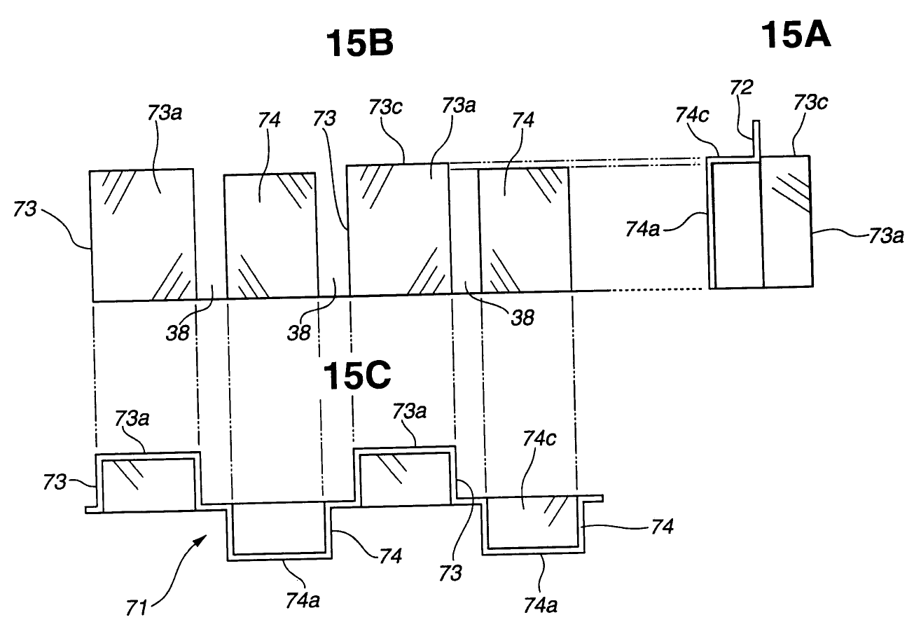

In the first to third embodiment, the generally trapezoidal projections are used in which the lower bottom corresponding to the base film is longer than the upper bottom corresponding to the crown portion in order to allow the embossing mold to be easily released. However, to increase the contact area of the crown portion, the thin-plate-like protective film 71 having generally rectangular projections 73 and 74 is applicable as shown in a fourth embodiment of the present invention in FIGS. 15A, 15B, and 15C. It should be appreciated that the surfaces of crown portions 73a and 74a of the projections 73 and 74, respectively, are parallel with the surface of a base film 72. Since the upper bottom is longer than the lower bottom, the contact area of the crown portion can be increased. Consequently, the tape-like structure 21 can be more stably protected without being deformed. The surfaces of side wall portions 73c and 74c are orthogonal to the surface of the base film 72. However, the orthogonality is not necessarily required. The illustration of the conductive layers 35 and 36 is omitted in FIG. 15.

(Fifth Embodiment)

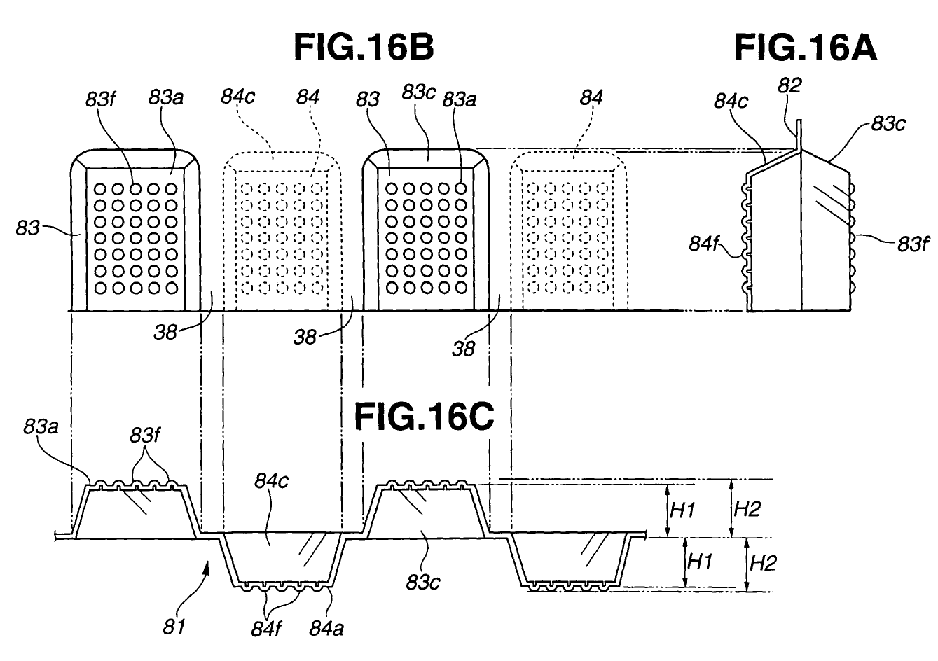

In the first to fourth embodiments, the crown portion constitutes a smooth surface. However, as shown in a fifth embodiment of the present invention in FIGS. 16A, 16B, and 16C, the base film 22 of the tape-like structure 21 can be supported substantially on a plane by using a thin-plate-like protective film 81 having a base film 82 with a plurality of projections 83 and 84 formed on the respective surfaces of the film 82, the projections 83 and 84 having contact points 83f and 84f, respectively, formed on their crown portions 83a and 84a, respectively and arranged in a matrix so as to contact two-dimensionally with the tape-like structure. The surface of each side wall portion 83c or 84c is not orthogonal to the surface of the base film 82 but may be so. The illustration of the conductive layers 35 and 36 is omitted in FIGS. 16A, 16B, 16C, and 16D.

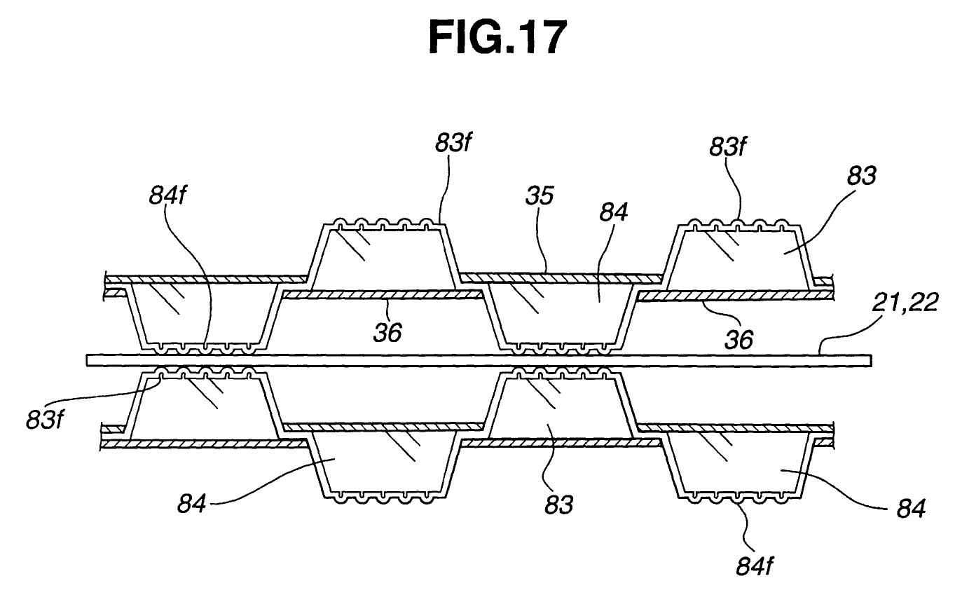

The heights H2 from the center of the base film 22 in its thickness direction to the contact points 83f and 84f are same. The height H2 is larger than the height H1 from the center of the base film 22 in its thickness direction to each of the contact points 83a and 84a. Consequently, as shown in FIG. 17, the plurality of contact points 83f on the projection 83 can contact substantially two-dimensionally with the base film 22 to stably grip the tape-like structure 21. This hinders the tape-like structure 21 from shifting relative to the thin-plate-like protective film 81 and similarly hinders the thin-plate-like protective films 81 from shifting relative to each other. Therefore, the tape-like structure 21 is unlikely to be crushed and deformed between the thin-plate-like protective films 81. Further, the tape-like structure 21 can be properly wound without frequently rubbing against the thin-plate-like protective film 81 or another part of the tape-like structure 21. The illustration of the semiconductor chips 23 and the interconnect patterns 24 is omitted in FIG. 17.

In the first to fourth embodiments, the crown portion of the projection is generally rectangular. However, it may be any quadrilateral, a polygon, or another shape. Likewise, the projection is generally trapezoidal as viewed from the side of the base film. However, the present invention is not limited to this shape.

(Sixth Embodiment)

For example, as shown in a sixth embodiment of the present invention in FIG. 18, a projection 100 may be U-shaped as viewed from one surface side of a base film 101. Specifically, that part of a crown portion 100a of the projection 100 which is opposite the end surface of the base film is semicircular. A side wall portion 100c of the projection 100 which is opposite the end surface of the base film 32 is a semicircular arc. The dimensions of the projection 100 are basically the same as those shown in, for example, FIGS. 5B and 5C. That is, the projection 100 is set to have a length L2 of about 4.5 mm, a width W1 of about 3.98 mm, and a width W2 of about 4.3 mm. The semicircular part of the crown portion 100a is set to have a radius R1 (=W1/2) of about 1.99 mm. The side wall portion 100c is set to have a radius R2 (=W2/2) of about 2.15 mm.

If the projection 100 is thus U-shaped, the connection of the semicircular side wall portion 100c to the linear side wall portion 100b extends in the tangential direction of the semicircular side wall portion 100c. In contrast, in FIG. 5B, the side wall portion 33c and the side wall portion 33b cross almost at right angles. As a result, if the projection is U-shaped, the mold can be properly released compared to the configuration shown in FIGS. 5A, 5B, and 5C. Further, the projection 100 has a substantially uniform thickness. Consequently, after embossing, reduced stress remains to hinder the corner portions of the projection 100 from being broken. That is, the projection 100 can resist shocks more successfully. Furthermore, since the outer periphery of that part of the crown portion 100a which is opposite the end surface of the base film 101 is semicircular, this semicircular part is in point contact with the base film of the tape-like structure. This makes the base film of the tape-like structure unlikely to be damaged.

(Seventh Embodiment)

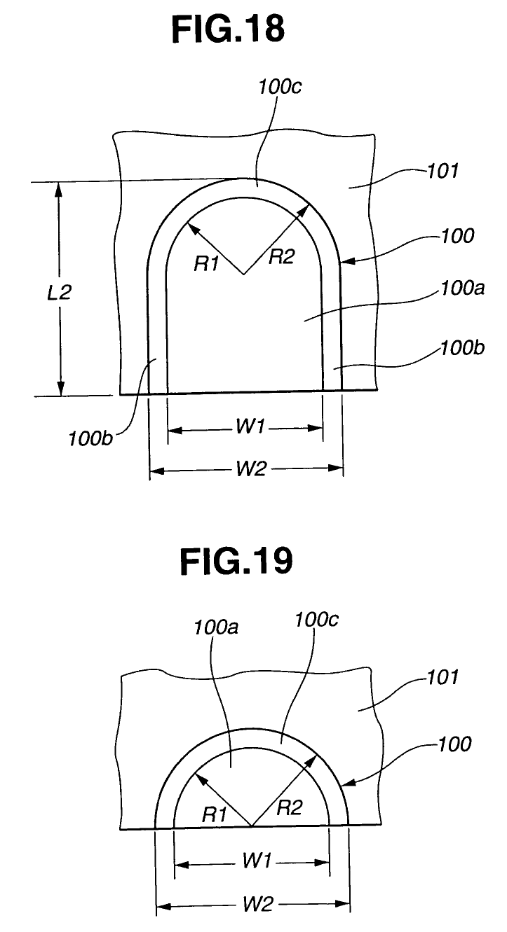

Further, as shown in a seventh embodiment of the present invention in FIG. 19, the projection 100 may be generally semicircular as viewed from one surface side of the base film 101. The dimensions of the projection 100 are basically the same as those shown in FIG. 18. That is, the projection 100 is set to have a width W1 of about 3.98 mm and a width W2 of about 4.3 mm. The semicircular part of the crown portion 100a is set to have a radius R1 (=W1/2) of about 1.99 mm. The side wall portion 100c is set to have a radius R2 (=W2/2) of about 2.15 mm.

If the projection 100 is thus generally semicircular, effects are obtained which are similar to those of the example shown in FIG. 18. This shape also serves to increase the intervals of the projections 100 on both sides in the width direction of the base film 101. It is thus possible to increase the width of that area of the tape-like structure 21, shown in, for example, FIG. 3, in which the interconnect patters 24 are formed.

In the first to sixth embodiment, the same projections 33 are arranged at the widthwise opposite ends of the base film 32 of the thin-plate-like protective film 31 so as to stand opposite each other, while the same projections 34 are arranged at the widthwise opposite ends of the base film 32 so as to stand opposite each other as shown in, for example, FIG. 1. However, the present embodiment is not limited to this aspect. Projections of the crown portions which project in different directions, such as the projections 33 and 34, may be arranged opposite each other. Alternatively, differently shaped projections may be arranged opposite each other. Furthermore, projections provided at one widthwise end may each be arranged opposite the gap portion 38 formed between a plurality of projections provided at the other end, rather than opposite one of the projections at the other end. That is, the projections may be asymmetrically arranged.

(Eighth Embodiment)

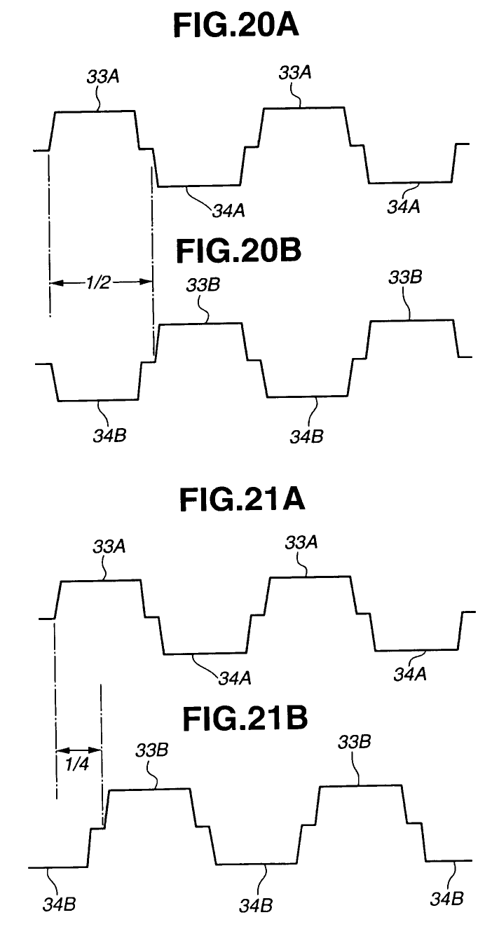

For example, as shown in a first example of eighth embodiment of the present invention in FIGS. 20A and 20B, projections 33A and 34A provided at one widthwise end of the thin-plate-like protective film may be shifted, by a ½ pitch, relative to the corresponding projections 33B and 34B provided at the other widthwise end. Alternatively, as shown in a second example of eighth embodiment of the present invention in FIGS. 21A and 21B, the projections 33A and 34A provided at one widthwise end of the thin-plate-like protective film may shifted, by a ¼ pitch, relative to the corresponding projections 33B and 34B provided at the other widthwise end.

In this case, if the amount by which the projections 33A and 34A provided at one widthwise end of the thin-plate-like protective film are shifted relative to the corresponding projections 33B and 34B provided at the other widthwise end is smaller than a ¼ pitch or larger than a ¾ pitch, the resulting configuration is similar to that shown in FIG. 1. Accordingly, to obtain effects similar to those of the thin-plate-like protective film 41 according to the third embodiment shown in FIG. 12, the amount of shifting is preferably about a ¼ to ¾ pitch, more preferably about a ½ pitch.

(Ninth Embodiment)

To form the interconnect patterns 24 on the tape-like structure 21 shown in FIG. 2, an etching resist film is patterned on the top surface of a copper foil stacked on the top surface of the base film 22. Then, etching is carried out using the etching resist film as a mask to form the interconnect patterns 24. Further, after the interconnect patterns 24 have been formed and before the semiconductor chips 23 are mounted, a solder resist film may be formed in the predetermined areas of the top surface of the base film 22 including the interconnect patterns 24, other than the areas in which the semiconductor chips 23 are mounted.

In this manner, a resist film consisting of an organic film, such as an etching resist film or a solder resist film, may be patterned in predetermined areas on the base film. Such a resist film is commonly formed by sequentially executing resist application, pre-baking, exposure, development, and post-baking. In this case, the pre-baking operation is performed to evaporate a solvent contained in the resist film. The post-baking operation is performed to improve the adhesion, chemical resistance, heat resistance, and electrical insulating property of the resist film.

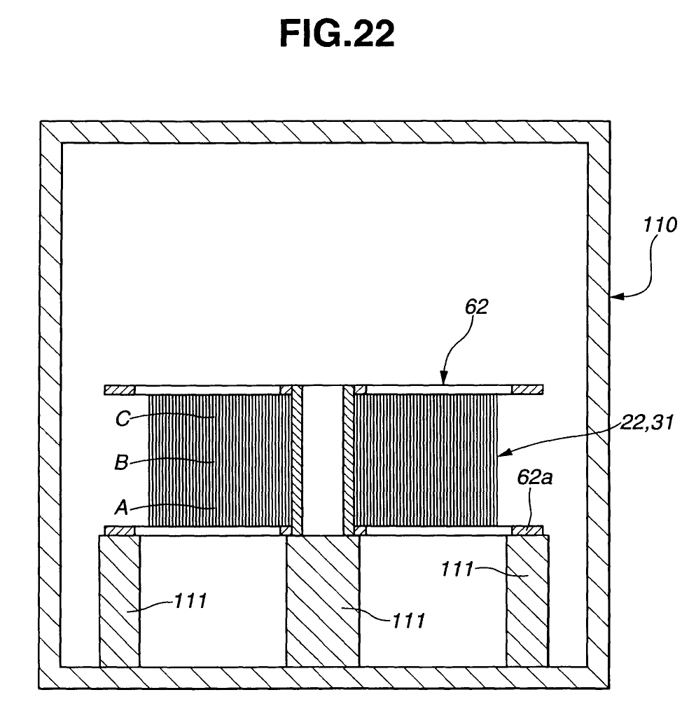

In this case, as a ninth embodiment of the present invention, description will be given of the case in which the base film 22 already subjected to a development step is wound around the reel together with the thin-plate-like protective film 31 and in which a post-baking step is then executed. First, as shown in FIG. 22, the base film 22 already subjected to a development step was wound around the reel 62 according to the present embodiment, together with the thin-plate-like protective film 31. The center and outer periphery of one flange 62a of the reel 62 were arranged on support portions 111 provided in a heating apparatus 110, such as an oven or a furnace. In this case, temperature sensors composed of thermocouples or the like were stuck to one surface of the base film 22 wound around the reel 62 and at the following three positions in the center of the base film 22 in the direction in which the base film 22 was wound: the bottom A, center B, and top C of reel in its width direction.

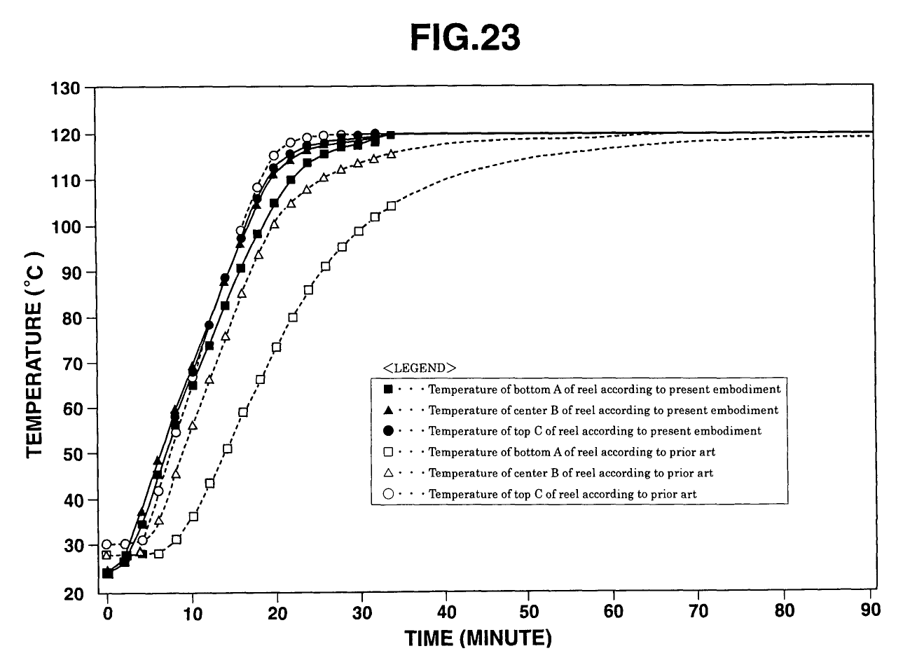

Then, an inert gas was introduced into the heating apparatus 110. In the inert gas atmosphere, the temperature was increased to a set value of 120° C. FIG. 23 shows the results. In FIG. 23, a solid line with black squares indicates the temperature of the bottom A of the reel according to the present embodiment. A solid line with black triangles indicates the temperature of the center B of the reel according to the present embodiment. A solid line with black circles indicates the temperature of the top C of the reel according to the present embodiment. Further, for comparison, experiments similar to those described above were conducted using a conventional thin-plate-like protective film with semispherical projection. Results shown by dotted lines in FIG. 23 were obtained. In FIG. 23, a dotted line with white squares indicates the temperature of the bottom A of the conventional reel. A dotted line with white triangles indicates the temperature of the center B of the conventional reel. A dotted line with white circles indicates the temperature of the top C of the conventional reel.

As is apparent from FIG. 23, with the prior art, indicated by the three dotted lines, the temperature increases in different ways. That is, the time required to reach the set temperature of 120° C. is about 40 minutes in the case of the dotted line with the white circles (the temperature of top C of the conventional reel) and about 90 minutes or more in the case of the dotted line with the white squares (the temperatures of bottom A of the conventional reel). Thus, the difference between these times is about 50 minutes or more.

In contrast, according to the present embodiment, shown by the three solid lines, the temperature increases in almost the same manner. The time required to reach the set temperature of 120° C. is about 40 minutes in all cases.

The reason why these results are obtained will be discussed below. According to the present embodiment, the base film 22 of the tape-like structure wound around the reel 62 together with the thin-plate-like protective film 31 is separated, by a predetermined distance, from the entire thin-plate-like protective film 31 except for the areas for the projections without being wavily deformed. Thus, the base film 22 of the tape-like structure is substantially uniformly heated all along its width direction. In contrast, according to the prior art, the base film of the tape-like structure wound around the reel together with the thin-plate-like protective film is wavily deformed. Thus, the base film of the tape-like structure is non-uniformly heated in its width direction.

As a result, according to the present embodiment, it is possible to substantially uniformly completely cure the resist film provided on one surface of the base film 22 of the tape-like structure, in a short time of about 40 minutes. In contrast, according to the prior art, it is only possible to non-uniformly completely cure the resist film provided on one surface of the base film of the tape-like structure, even though it takes a long time of about 90 minutes or more for the complete cure. Further, a cooling characteristic is substantially uniform according to the present embodiment but is non-uniform according to the prior art. Thus, the present embodiment accomplishes both uniform heating and cooling characteristics. Therefore, after the complete cure, the resist film has substantially uniform characteristics.

(Other Embodiments)

Provided that the interconnect patterns 24 (and the semiconductor chips 23) are formed on only one surface of the base film of the tape-like structure, projections may be provided only on that surface of the base film of the tape-like structure on which the interconnect patterns 24 are provided. This forms the space 37 that serves to prevent the thin-plate-like protective film from contacting with the interconnect patterns 24 (and the semiconductor chips 23).

Further, in the above embodiments, the gap portion 38 is formed between the plurality of projections provided at the same end. Accordingly, when the tape-like structure is wound around the reel, the gap portion 38 between the projections is flexed or the root between the gap portion 38 and the projection is bent to allow the base film of the thin-plate-like protective film to be easily bent along the reel 62. However, to increase the ratio of area in which the base film of the tape-like structure contacts with the crown portions of the thin-plate-like protective film, the side wall portions of the adjacent projections may be formed to be continuous instead of forming the gap portions 38. Further, in the above embodiments, the gap portions 38 have an equal width. However, by allowing at least some of the gap portions 38 to have different widths as required, effects can be obtained which are similar to those of the thin-plate-like protective film of the third embodiment, shown in FIG. 12.

Furthermore, in the description of the above embodiments, to execute manufacturing steps on a roll to roll basis, the long tape-like structure is superimposed on the long thin-plate-like protective film when wound around the reel. However, the present invention is not limited to this aspect. For example, a reel may be shipped around which a long tape-like structure is wound so as to be superimposed on a long thin-plate-like protective film. Further, when a product is manufactured in sheet form, a tape-like sheet structure may be superimposed on a tape-like sheet structure. Furthermore, it is also recommended to carry and ship a product in which a plurality of tape-like structures shaped like sheets and a plurality of thin-plate-like protective films shaped like sheets are alternately stacked together.

When a tape-like sheet structure and a thin-plate-like sheet protective film are superimposed on each other, if the tape-like structure has a relatively small size of, for example, about 5×5 cm, then projections may be provided on two opposite sides, respectively, of a thin-plate-like protective film of the corresponding size. Alternatively, projections may be provided on four sides of the thin-plate-like protective film. In this case, the projections may be line-symmetrically or non-line-symmetrically provided on the two opposite sides.

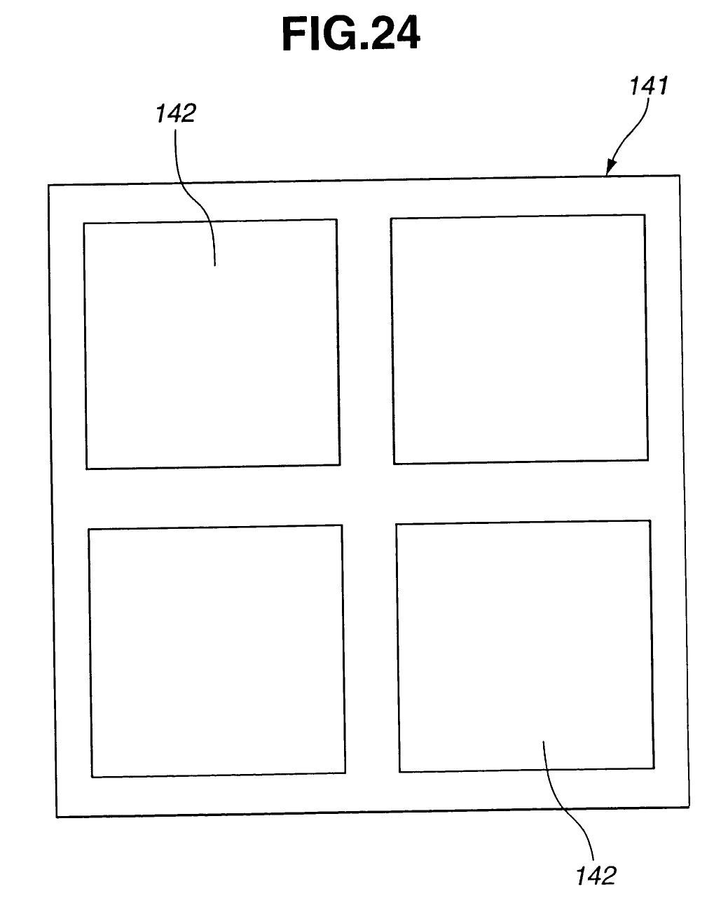

Further, as shown in FIG. 24, if a tape-like sheet structure 141 has a relatively large size of, for example, 100×100 cm and square final product areas 142 are arranged over the whole area of the tape-like structure 141 other than its four side areas, i.e. in its center, and in two rows and two columns so as to spaced from one another, then projections 144 and 145 may be provided both in the four side areas of a thin-plate-like sheet protective film having a corresponding size and in areas corresponding to the cross-shaped gap between the final product areas 142, arranged in two rows and two columns.

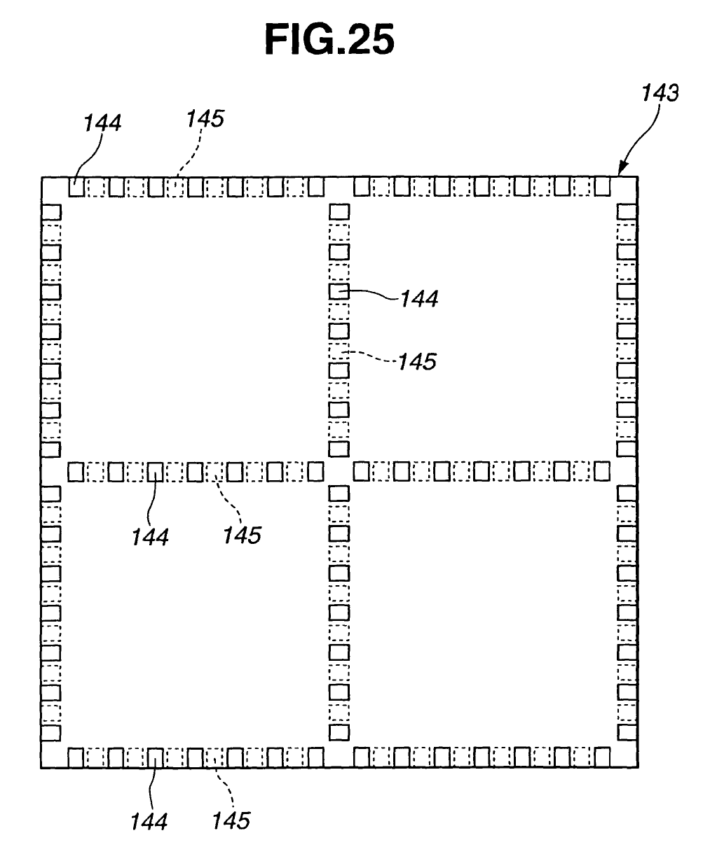

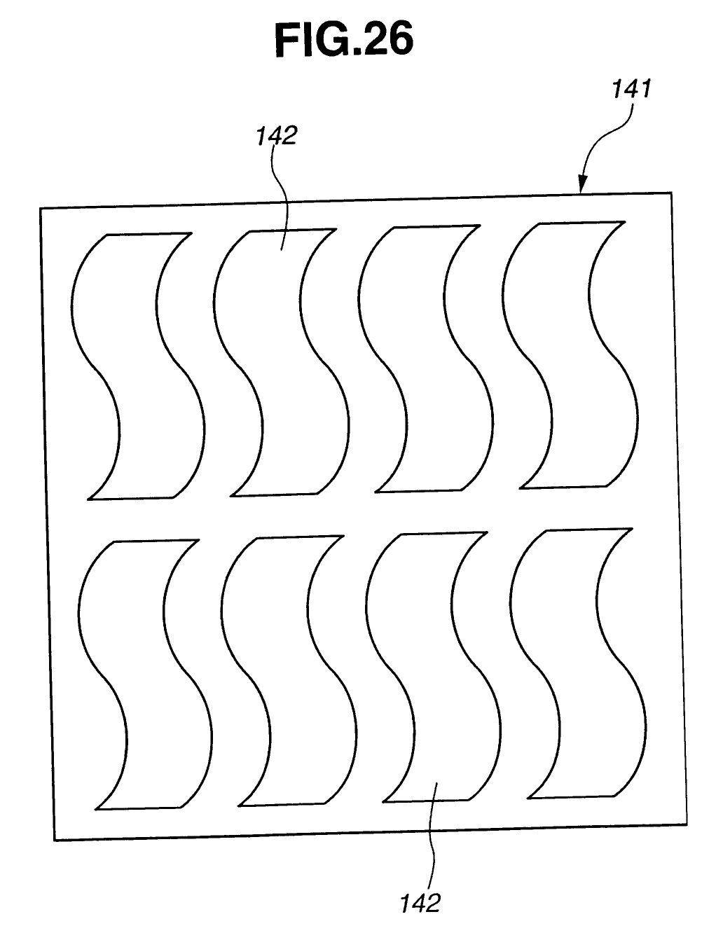

In FIG. 25, the projections 144, shown by solid lines, project from the top surface of the thin-plate-like protective film 143. On the other hand, the projections 145, shown by dotted lines, project from the bottom surface of the thin-plate-like protective film 143. In this case, the projections 144 and 145 may be line-symmetrically or non-line-symmetrically provided on the two opposite sides of the thin-plate-like protective film 143. Further, the projections 144 and 145 may have the same planar size. Alternatively, the projections 144 and 145 arranged in cross form may have a smaller planar size than the projections 144 and 145 arranged in the four side areas.

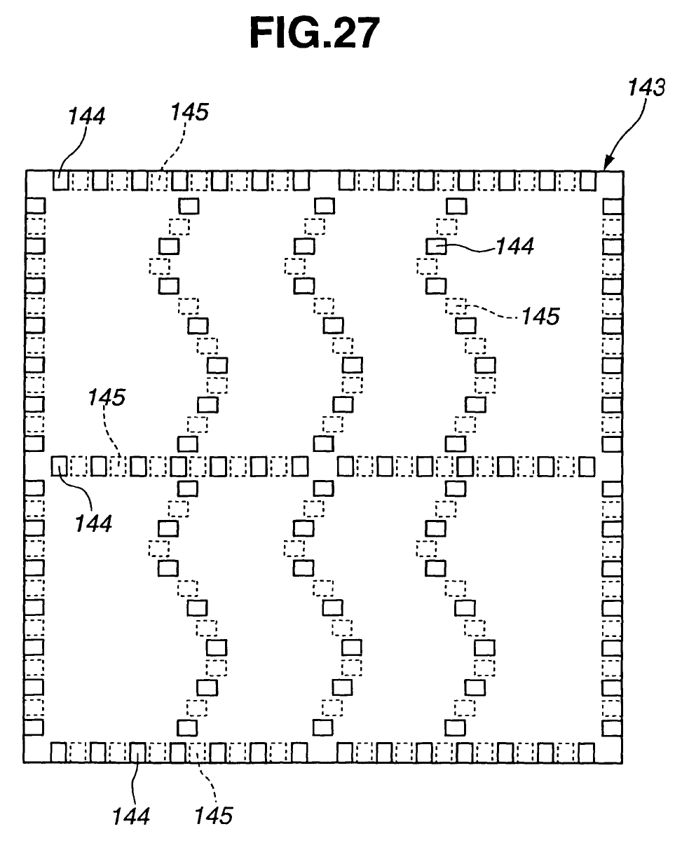

Further, as shown in FIG. 26, if the tape-like sheet structure 141 has a relatively large size of, for example, 100×100 cm and generally S-shaped final product areas 142 are arranged over the whole area of the tape-like structure 141 other than its four side areas, i.e. in its center, and in four rows and two columns so as to be spaced from one another, then as shown in, for example, FIG. 27, the projections 144 and 145 may be linearly provided in the four side areas and column-wise center of the thin-plate-like sheet protective film 143 and have a corresponding size. The projections 144 and 145 may further be provided in those areas of the thin-plate-like protective film 143 which correspond to generally-S-shaped gaps each located between the generally-S-shaped final product areas arranged in the row direction.

In FIG. 27, the projections 144, shown by solid lines, project from the top surface of the thin-plate-like protective film 143. On the other hand, the projections 145, shown by dot lines, project from the bottom surface of the thin-plate-like protective film 143. In this case, the projections 144 and 145 may be line-symmetrically or non-line-symmetrically provided on the two opposite sides of the thin-plate-like protective film 143. Further, the projections 144 and 145 may have the same planar size. Alternatively, the projections 144 and 145 arranged in generally S shaped form and arranged in the column-wise center may have a smaller planar size than the projections 144 and 145 arranged in the four side areas. Alternatively, only the projections 144 and 145 arranged in generally S shaped form may have a smaller planar size than the other projections 144 and 145.

Only the interconnect patterns may be provided on the base film of the tape-like structure. Further, only the semiconductor chips may be mounted on the interconnect patterns. Furthermore, electronic components such as capacitors, resistors, and coils may be mounted on the interconnect patterns.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A thin-plate-like protective film comprising a thin-plate-like material main body which protects a protected thin-plate-like material structure,
wherein projections are arranged continuously in predetermined areas of the thin-plate-like material main body so as to extend from the main body, the projections each having a crown portion, a surface of which is substantially parallel with a main surface of the protected thin-plate-like material structure, and a side wall portion surrounding the crown portion.

2. The thin-plate-like protective film according to claim 1, wherein a surface of the crown portion is a plane.

3. The thin-plate-like protective film according to claim 1 or 2, wherein the crown portion is provided with a plurality of contacts.

4. The thin-plate-like protective film according to claim 1 or 2, wherein the side wall portion is inclined.

5. The thin-plate-like protective film according to claim 1 or 2, wherein the crown portions of the plurality of projections project in different directions from the main surface of the thin-plate-like material main body.

6. The thin-plate-like protective film according to claim 1 or 2, wherein the plurality of projections include first projections projecting from one surface of thin-plate-like material main body, and second projections projecting from the other surface of thin-plate-like material main body, the first and second projections being arranged alternately along a direction in which the projections are arranged.

7. The thin-plate-like protective film according to claim 1 or 2, wherein the plurality of projections have an equal width in the direction in which the projections are arranged.

8. The thin-plate-like protective film according to claim 1 or 2, wherein the plurality of projections have different widths in the direction in which the projections are arranged.

9. The thin-plate-like protective film according to claim 1 or 2, wherein the plurality of projections are line-symmetrically arranged.

10. The thin-plate-like protective film according to claim 1 or 2, wherein the plurality of projections are non-line-symmetrically arranged.

11. The thin-plate-like protective film according to claim 1 or 2, wherein a gap portion is formed between the plurality of projections.

12. The thin-plate-like protective film according to claim 1 or 2, wherein some of the plurality of gap portions have an equal width.

13. The thin-plate-like protective film according to claim 1 or 2, wherein some of the plurality of gap portions have different widths.

14. The thin-plate-like protective film according to claim 1 or 2, wherein the projection is generally trapezoidal as viewed from an end surface side of the thin-plate-like material main body.

15. The thin-plate-like protective film according to claim 1 or 2, wherein the projection is U-shaped as viewed from one surface side of the thin-plate-like material main body.

16. The thin-plate-like protective film according to claim 1 or 2, wherein the projection is generally semicircular as viewed from one surface side of the thin-plate-like material main body.

17. The thin-plate-like protective film according to claim 1 or 2, wherein the protected thin-plate-like material structure comprises interconnect patterns so that the predetermined areas of the thin-plate-like material main body are not superimposed on the interconnect patterns.

18. The thin-plate-like protective film according to claim 1 or 2, wherein the protected thin-plate-like material structure comprises interconnect patterns and electronic components so that the predetermined areas of the thin-plate-like material main body are not superimposed on the interconnect patterns or electronic components.

19. The thin-plate-like protective film according to claim 18, wherein the electronic components are semiconductor chips.

20. The thin-plate-like protective film according to claim 1 or 2, wherein the thin-plate-like material main body is long enough to protect the protected thin-plate-like material structure, which is also long.

21. The thin-plate-like protective film according to claim 20, wherein the protected thin-plate-like material structure comprises sprocket holes so that the predetermined areas of the thin-plate-like material main body are in proximity to the sprocket holes.

22. The thin-plate-like protective film according to claim 20, wherein the protected thin-plate-like material structure comprises sprocket holes at its widthwise opposite ends, and the predetermined areas of the thin-plate-like material main body are widthwise opposite ends of the thin-plate-like material main body.

23. The thin-plate-like protective film according to claim 1 or 2, wherein the thin-plate-like material main body has a sheet form so as to protect the protected thin-plate-like material structure, which also has a sheet form.

24. The thin-plate-like protective film according to claim 23, wherein the predetermined areas of the thin-plate-like material main body are two opposite side areas of the thin-plate-like material main body.

25. The thin-plate-like protective film according to claim 23, wherein the predetermined areas of the thin-plate-like material main body are at least four side areas of the thin-plate-like material main body.

26. A thin-plate-like protective film comprising a long thin-plate-like material main body which protects a long protected thin-plate-like material structure, wherein conductive layers are provided at least in areas of the thin-plate-like material main body other than at its widthwise opposite ends.

27. The thin-plate-like protective film according to claim 26, wherein the conductive layers are provided on respective surfaces of the thin-plate-like material main body.
